(19) United States
(12) Patent Application Publication
(10) Pub. No.: US 2012/0188629 A1
(43) Pub. Date: Jul. 26, 2012

(54) PROJECTION DEVICE

(75) Inventor: YUNG-LUN HUANG, Tu-Cheng (TW)

(73) Assignee: HON HAI PRECISION INDUSTRY CO., LTD., Tu-Cheng (TW)

(21) Appl. No.: 13/097,063

(22) Filed: Apr. 29, 2011

(30) Foreign Application Priority Data
Jan. 25, 2011 (TW) 100102582

(51) Int. Cl. G02B 26/00

(52) U.S. Cl. 359/292

(57) ABSTRACT

A projection device includes a light source, three digital micromirror devices (DMDs), a projection lens module, and three converging lenses. The light source emits light towards the three DMDs. Each DMD includes a plurality of reflective mirrors. The projection lens module projects light to a screen. Each reflective mirror selectively reflects light to the projection lens module. Each converging lens is positioned between the projection lens module and a respective DMD.

### BACKGROUND

1. Technical Field

The present disclosure relates to a projection device.

2. Description of Related Art

In a digital lighting process projection device, each digital micromirror device (DMD) includes a plurality of reflective mirrors arranged in an array. When a reflective mirror reflects light, some light may be reflected to a screen without passing a projection lens module due to a slight error in rotation of the reflective mirror. The light may cause the projection image to be unsatisfactory.

Therefore, it is desirable to provide a new projection device, which can overcome the above-mentioned limitations.

### BRIEF DESCRIPTION OF THE DRAWINGS

FIG. 1 is a schematic view of a projection device according to an embodiment.

FIG. 2 is a schematic view of a DMD of the projection device of FIG. 1.

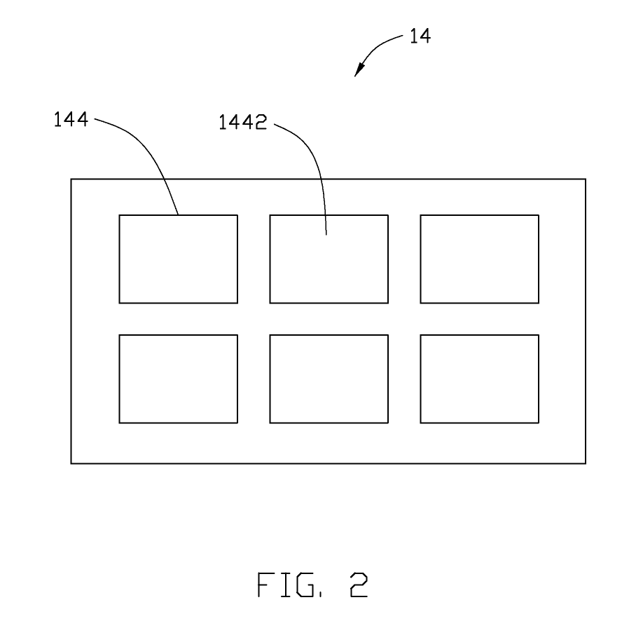

### DETAILED DESCRIPTION

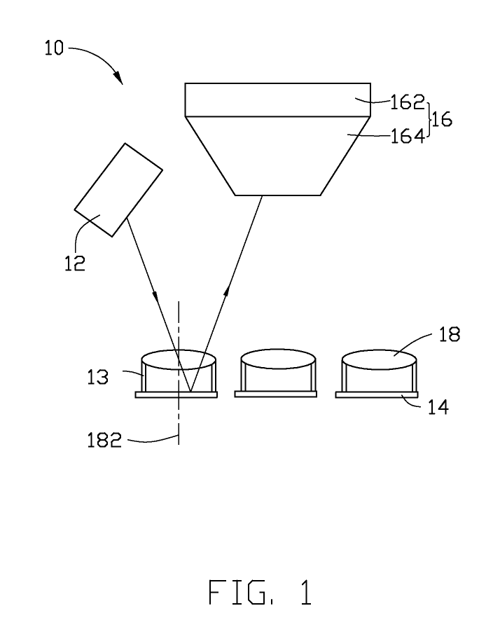

Referring to FIG. 1, a projection device 10 includes a light source 12, three DMDs 14, a converging lens 18, and a projection lens module 16. In the present embodiment, the projection device 10 is a DLP projection device.

The light source 12 is configured for emitting light to the three

DMDs 14. In the present embodiment, the light source 12 is a white light source, for example, a white LED.

The three DMDs 14 are respectively configured for reflecting red, green, and blue light. Each DMD 14 includes a plurality of reflective mirrors 144 arranged in a rectangular array. Each DMD 14 controls a rotation of each reflective mirror 144, so that each mirror 144 reflects light selectively. In this embodiment, each reflective mirror 144 reflects useful light to the projection lens module 16, and reflects useless light to outer surface of the projection lens module 16.

The projection lens module 16 is adapted to project light to a screen (not shown). The projection lens module 16 can be a fixed focus lens module or a variable focus lens module. The projection lens module 16 includes a cylindrical portion 162, and a truncated cone portion 164. The cylindrical portion 162 is connected with the truncated cone portion 164. An end surface with a small diameter of the truncated cone portion 164 faces away from the cylindrical portion 162. A sidewall of the projection lens module 16 is made of light absorption material. When light reaches the outer surface of the projection lens module 16, the light is absorbed.

Each converging lens 18 is mounted on a respective DMD 14, and is positioned between the respective DMD 14 and the projection lens module 16. Each converging lens 18 is configured for converging light reflected by the respective DMD 14. In the present embodiment, each converging lens 18 is a Fresnel lens. Fresnel lenses are easy to make, and still have a light converging function when partly damaged. Each converging lens 18 is mounted on the respective DMD 14 via a transparent bracket 13.

When each reflective mirror 144 of a DMD 14 is in a natural state (i.e., without rotation), the reflective surfaces 1442 of the reflective mirrors 144 are substantially coplanar, and cooperatively form a surface. An optical axis 182 of each converging lens 18 is substantially perpendicular to the reflective surfaces 1442 of the respective DMD 14. When an orthographic projection area of each converging lens 18 covers all the reflective surfaces 1442 of the respective DMD 14, the projection device 10 has the highest optical efficiency.

In use, the light source 12 emits light to the three DMDs 14, the reflective mirrors 144 of each DMD 14 reflect light, some of the light is then converged to pass through the projection lens module 16, and the rest of the light is converged to reach outer surface of the projection lens module 16. The light passing through the projection lens module 16 forms an image on the screen.

In the projection device 10, light ray is reflected by the reflective mirrors 144 and is converged by the converging lens 18. The converged light ray has a small diameter, so it is easy for reflective mirrors 144 to reflect light to a precise position. Therefore, the quality of the projection image is improved.

While various embodiments have been described, it is to be understood that the disclosure is not limited thereto. To the contrary, various modifications and similar arrangements (as would be apparent to those skilled in the art), are also intended to be covered. Therefore, the scope of the appended claims should be accorded the broadest interpretation so as to encompass all such modifications and similar arrangements.

What is claimed is:

1. A projection device comprising:
a light source configured for emitting light;
a plurality of digital micromirror devices (DMDs), each DMD comprising a plurality of reflective mirrors, each reflective mirror being configured for selectively reflecting the light emitted from the light source; and
a plurality of converging lenses, each converging lens being aligned with a corresponding DMD and configured for converging the reflected light from the corresponding DMD; and
a projection lens module configured for projecting the converged light from the converging lenses to a screen.

2. The projection device of claim 1, wherein each converging lens is mounted on the corresponding DMD.

3. The projection device of claim 1, wherein an optical axis of each converging lens is substantially perpendicular to a surface of the corresponding DMD.

4. The projection device of claim 1, wherein an orthographic projection area of each converging lens covers the surface of the corresponding DMD.

5. The projection device of claim 1, wherein the projection device comprises a digital lighting process projection device.

6. The projection device of claim 1, wherein the light source comprises a white light source.

7. The projection device of claim 6, wherein the white light source comprises a white LED.

8. The projection device of claim 1, wherein the projection lens module is a variable focus lens module.

9. The projection device of claim 1, wherein each converging lens comprises a Fresnel lens.
